(19) United States
(12) Patent Application Publication
(10) Pub. No.: US 2008/0144173 A1
(43) Pub. Date: Jun. 19, 2008

(54) MULTI-DISPLAY APPARATUS AND METHOD OF MANUFACTURING THEREOF

(75) Inventors: Ki-deok Bae, Yongin-si (KR); Jun-seong Kim, Yongin-si (KR); Euk-che Hwang, Yongin-si (KR); Chan-bong Jun, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/832,921

(22) Filed: Aug. 2, 2007

(30) Foreign Application Priority Data
Dec. 15, 2006 (KR) 10-2006-0128944

(51) Int. Cl. G03B 21/56

(52) U.S. Cl. 359/460

(57) ABSTRACT

A multi-display apparatus includes a plurality of panels connected to each other and displaying an image, wherein the plurality of panels comprise a top emission type display apparatus and a bottom emission type display apparatus, and the top emission type display apparatus and the bottom emission type display apparatus are connected to each other such that the top emission type display apparatus and the bottom emission type display apparatus emit light in a same direction, and the top emission type display apparatus and the bottom emission type display apparatus are arranged with a step difference therebetween such that pixel boundaries of adjacent side boundary surfaces of the top emission type display apparatus and of the bottom emission type display apparatus overlap each other.

This application claims priority to Korean Patent Application No. 10-2006-0128944, filed on Dec. 15, 2006, and all the benefits accruing therefrom under 35 U.S.C. §119, the contents of which in its entirety are herein incorporated by reference.

### BACKGROUND OF THE INVENTION

1. Field of the Invention

The present invention relates to a multi-display apparatus which realizes an image by connecting a plurality of panels, and more particularly, to a multi-display apparatus which can minimize image disconnection at seams between the panels of the multi-display apparatus.

2. Description of the Related Art

Conventionally, multi-display apparatuses realize a large screen by connecting a plurality of unit display panels. In the past, a large screen was realized by connecting a plurality of Brown Tubes or cathode ray tubes (“CRTs”) into a large television. However, recently, due to an increasing demand for a large screen in small mobile apparatuses such as mobile phones or personal digital assistants (“PDAs”), apparatuses that realize a large screen by connecting flat panel displays such as liquid crystal displays (“LCDs”), field emission displays (“FEDs”), plasma display panels (“PDPs”) and organic light-emitting diodes (“LEDs”) are being produced.

Conventionally, multi-display apparatuses are manufactured by connecting a plurality of unit panels 10 in parallel. FIG. 1 is a cross-sectional schematic diagram view illustrating a conventional multi-display apparatus of the prior art including a pair of unit panels 10. Referring to FIG. 1, a multi-screen is realized by connecting the unit panels 10 in parallel. However, an image at a seam between the unit panels 10 is not smoothly formed when the unit panels 10 are connected to each other in parallel, and the unit panels 10 become frequently disconnected at the seam therebetween. As schematically depicted in FIG. 1, each of the unit panels 10 has a sealing structure in which a display device 12 that forms a pixel is mounted on a substrate glass 11 and a cover glass 13, which covers the display device 12, is attached to the substrate glass 11. As such, the cover glass 13 basically has a rim thickness t and the display device 12 is located on an inner portion of the cover glass 13. Therefore, a disconnection distance w exists at the seam between the display devices 12. The distance w between the display devices 12 cannot be readily reduced since the distance w is inevitably required for the cover glasses 13 to safely protect the display devices 12 by covering the display devices 12. Therefore, there is a limitation in reducing the image disconnection at the seam between the unit panels 10 in the above parallel connection structure.

To overcome this limitation, as depicted in FIG. 2, a structure has been previously proposed in which a pair of first and second unit panels 21 and 22 are disposed with a step difference therebetween and pixel boundaries of the first and second unit panels 21 and 22 are vertically aligned along a line L. That is, after the first and second unit panels 21 and 22 are disposed with the step difference therebetween as depicted in FIG. 2, a right side boundary surface of a pixel 21b of the first unit panels 21 is vertically aligned with a left side boundary surface of a pixel 22b of the second unit panel 22 along the vertical line L. In such form, the image disconnection at a seam between the first and second unit panels 21 and 22 is minimized when an image that is to be displayed on the first and second unit panels 21 and 22 is viewed from a plan view. Accordingly, the image partially displayed on the first and second unit panels 21 and 22 is seen as a connected image when viewed from the plan view.

As described above, when the first and second unit panels 21 and 22 are vertically aligned, the image disconnection at the seam between the first and second unit panels 21 and 22 is minimized. However, since a height difference between the first and second unit panels 21 and 22 increases, a perspective of a connected image thereby occurs. That is, a distance between a light emitting surface of the display device 21b and a viewer differs from a distance between a light emitting surface of the display device 22b and the viewer by a height difference h1 between substrates 21a and 22a of the first and second unit panels 21 and 22, respectively. Thus, as the height difference h1 increases, the viewer may experience further distortion of the connected image. Although FIGS. 1 and 2 illustrate top emission type display apparatuses emitting light towards the substrates 21a and 22a, a height difference also occurs if the first and second unit display apparatuses 21 and 22 are bottom emission type display apparatuses emitting light towards covers 21c and 22c. Conventionally, the multi-display apparatus of the prior art as described above is a folder type in which two panels are connected together by a hinge for improved portability or the like. That is, when the multi-display apparatus is transported, the first and second unit panels 21 and 22 are folded so as to overlap with each other. When the multi-display apparatus is put to use, the first and second unit panels 21 and 22 are unfolded so as to display one connected image, as illustrated in FIGS. 1 and 2. Accordingly, since the first and second unit panels 21 and 22 display one connected image when unfolded, an air gap G between the first and second unit panels 21 and 22 is present, however well one may adjust mechanical sizes in a vertical stack structure, as illustrated in FIG. 3. Accordingly, the perspective of the connected image is further increased.

Accordingly, there is a need to develop a multi-display apparatus that can overcome image disconnection at the seam between a pair of panels and can reduce distortion due to the perspective of the image.

### BRIEF SUMMARY OF THE INVENTION

The present invention provides a multi-display apparatus which can minimize image disconnection at a seam between panels of the multi-display apparatus and can also reduce distortion due to a perspective of a connected image of the panels.

The present invention provides a method of manufacturing the multi-display apparatus which can minimize image disconnection at a seam between panels of the multi-display apparatus and can also reduce distortion due to a perspective of a connected image of the panels.

According to an exemplary embodiment of the present invention, there is provided a multi-display apparatus including a plurality of panels connected to each other and displaying an image, wherein the plurality of panels may include a top emission type display apparatus and a bottom emission type display apparatus, the top emission type display apparatus and the bottom emission type display apparatus are connected to each other such that the top emission type display apparatus and the bottom emission type display apparatus emit light in a same direction, and the top emission type display apparatus and the bottom emission type display apparatus are arranged with a step difference therebetween such that pixel boundaries of adjacent side boundary surfaces of the top emission type display apparatus and of the bottom emission type display apparatus overlap each other.

In an exemplary embodiment, the multi-display apparatus may further include a cover which surrounds each panel of the plurality of panes and a substrate on which each panel of the plurality of panels is attached to.

In an exemplary embodiment, the top emission type display apparatus may project an image through the substrate, and the bottom emission type display apparatus projects an image through the cover.

In an exemplary embodiment, the top emission type display apparatus and the bottom emission type display apparatus are connected to each other by a hinge-type connection.

In an exemplary embodiment, the multi-display apparatus may further include a transparent member formed on one of the top emission type display apparatus and the bottom emission type display apparatus, wherein the display apparatus on which the transparent member is formed may include a smaller thickness than a thickness of the other display apparatus, the thickness corresponds to a distance through which light is emitted.

In an exemplary embodiment, the transparent member may be formed such that refraction indexes and absorption rates of light emitted from the top emission type display apparatus and the bottom emission type display apparatus are substantially the same.

According to an exemplary embodiment of the present invention, there is provided a method of manufacturing the multi-display apparatus as discussed above.

### BRIEF DESCRIPTION OF THE DRAWINGS

The above and/or other aspects, features and advantages of the present invention will become more apparent by describing in detail exemplary embodiments thereof with reference to the attached drawings, in which:

FIG. 1 is a cross-sectional schematic diagram view illustrating a conventional multi-display apparatus of the prior art;

FIG. 2 is a cross-sectional schematic diagram view illustrating another conventional multi-display apparatus of the prior art;

FIG. 3 is an enlarged schematic diagram view of an air gap formed between unit panels in the conventional multi-display apparatus of FIG. 2;

FIG. 4 is a top plan schematic diagram view illustrating an exemplary embodiment of a multi-display apparatus according to the present invention;

FIG. 5 is a cross-sectional schematic diagram view illustrating an exemplary embodiment of a connection structure of unit panels in the multi-display apparatus of FIG. 4 according to the present invention;

FIGS. 6A and 6B are schematic diagram views for comparing the exemplary embodiment of a connection structure of FIG. 5 with the conventional multi-display apparatus of FIG. 2, respectively; and

FIG. 7 is a cross-sectional schematic diagram view illustrating a modified version of the exemplary embodiment of a connection structure of the panels of FIG. 5 according to the present invention.

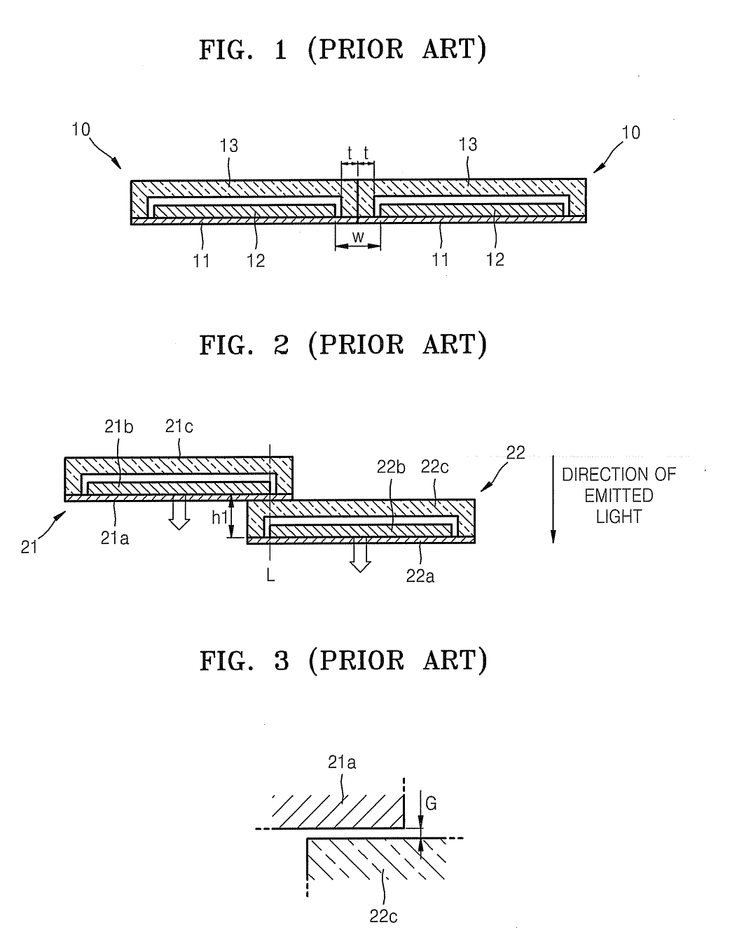

### DETAILED DESCRIPTION OF THE INVENTION

The invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those of ordinary skill in the art.

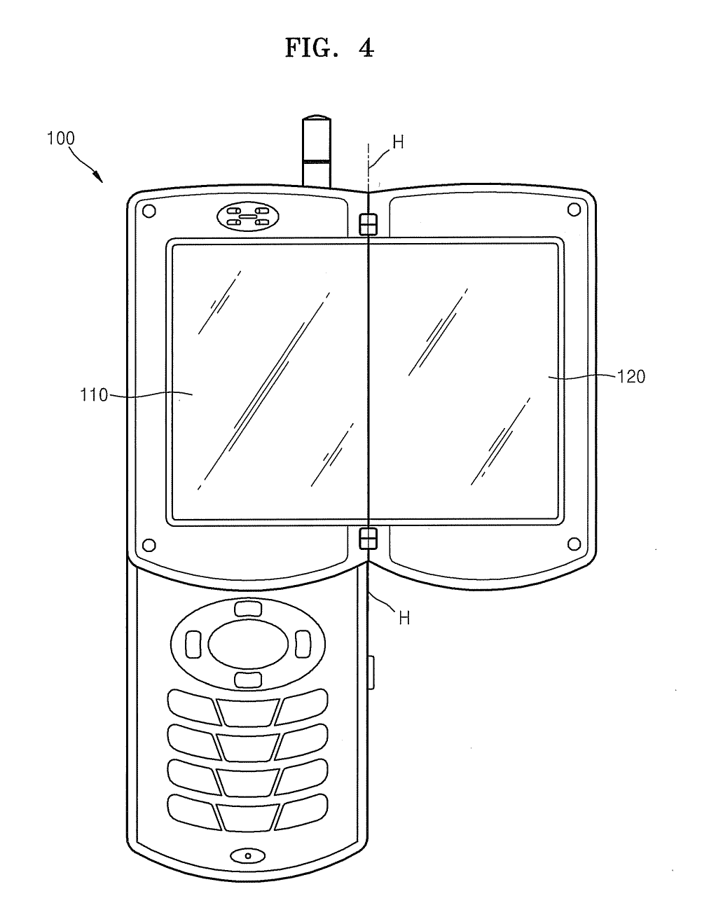

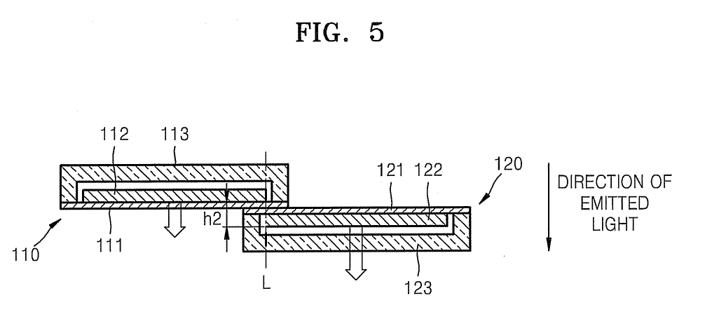

FIG. 4 is a front schematic diagram view illustrating an exemplary embodiment of a multi-display apparatus 100 according to the present invention. FIG. 5 is a cross-sectional schematic diagram view illustrating an exemplary embodiment of a connection structure of unit panels 110 and 120 of the multi-display apparatus 100 of FIG.4 according to the present invention. Although a multi-display apparatus 100 may be formed by connecting a plurality of panels in various ways in exemplary embodiments, in the current exemplary embodiment, for convenience of description, a case where a pair of unit panels 110 and 120 is connected will be described.

As depicted in FIG. 5, the unit panels 110 and 120 include structures in which display devices 112 and 122 for displaying images are respectively stacked on substrates 111 and 121, and covers 113 and 123 which surround the display devices 112 and 122 are attached to the substrates 111 and 121, respectively.

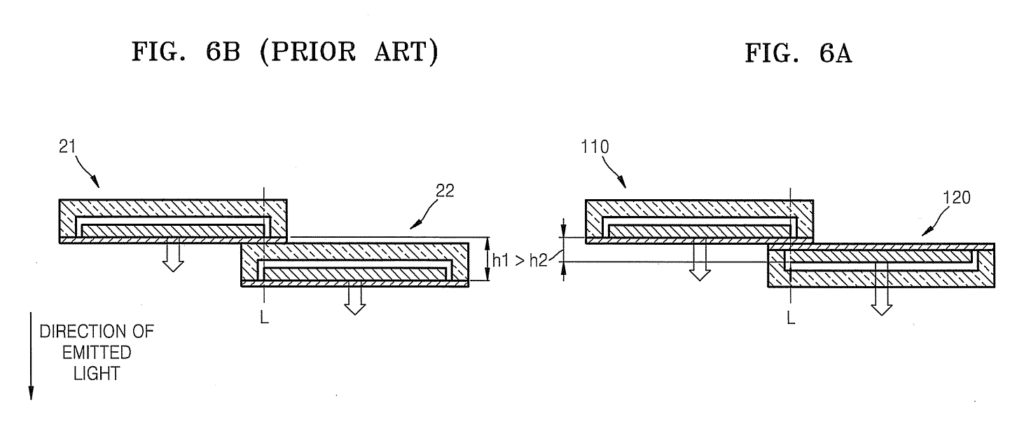

In an exemplary embodiment, as depicted in FIG. 4, the pair of unit panels 110 and 120 form a multi-image display by being connected together with a hinge-type connection, in which the unit panels 110 and 120 may be folded and unfolded with respect to a hinge axis H. However, the present invention is not limited to a hinge-type connection. The unit panels 110 and 120 are configured to include a step difference between the unit panels 110 and 120, as depicted in FIG. 5, when the unit panels 110 and 120 are unfolded. The multi-display apparatus 100 is a structure in which boundaries of the display devices 112 and 122 are aligned along line L such that an image is seen as if the image is connected when a seam between the unit panels 110 and 120 is viewed from a top plan view. In the unit panels 110 and 120 connected to include the step difference, a left unit panel 110 and a right unit panel 120 emit light in opposite directions of each other. That is, the left unit panels 110 is a top emission type display apparatus which projects an image generated from the display device 112 through the substrate 111 of a main body, and the right unit panels 120 is a bottom emission type display apparatus which projects an image through the cover 123. In a conventional display apparatus of the prior art, top emission type display devices are exclusively connected to each other, or bottom emission type display devices are exclusively connected to each other. However, in the current exemplary embodiment of the present invention, a top emission type display apparatus and a bottom emission type display apparatus are connected to each other so as to emit light in the same direction in order to reduce a height difference between adjacent panels. FIGS. 6A and 6B are schematic diagram views for comparing the exemplary embodiment of a connection structure including the left and right unit panels 110 and 120 in the multi-display apparatus 100 of FIG. 5 with the conventional multi-display apparatus of FIG. 2, respectively. Referring to FIG. 6A, in the multi-display apparatus 100 of FIG. 5, the top emission type display apparatus, that is, the left unit panel 110, and the bottom emission type panels, that is, the right unit panel 120, are connected together so as to emit light in the same direction, while on the other hand, in the conventional multi-display appartus of FIG. 2, two top emission type display apparatuses, that is, the first and second unit panels 21 and 22 are connected to each other. That is, when the top emission type display apparatus, that is, the left unit panels 110, and the bottom emission type display apparatus, that is, the right unit panels 120, are connected together according to the current exemplary embodiment of the present invention, the height difference h2 between light emitting surfaces of the display devices 1 12 and 122, which corresponds approximately to the thickness of each of the covers 113 and 123, is smaller by h1-h2 than the thickness of the conventional case where two top emission type display apparatuses are connected to each other. Accordingly, a perspective between the left and right unit panels 110 and 120 is thereby reduced, and thus the image is smoothly connected. That is, a right side boundary surface of the display device 112 and a left side boundary surface of the display device 122 overlap each other, and thus, the image disconnection at the seam between the left and right unit panels 110 and 120 may be reduced. Simultaneously, the top emission type display apparatus and the bottom emission type display apparatus are connected, and thus the perspective due to the step difference between the top emission type display apparatus and the bottom emission type display apparatus can be minimized. Therefore, an image on the multi-display apparatus 100 of FIG. 4 can be smoothly connected.

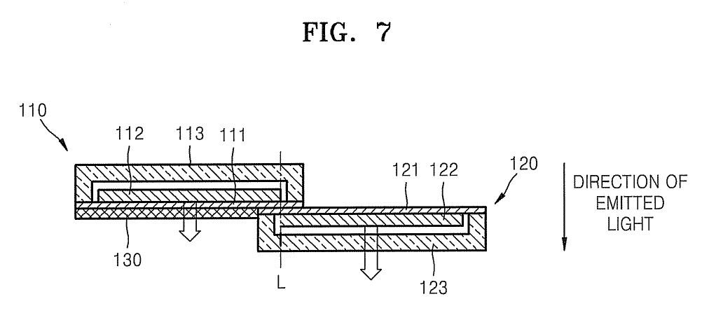

Meanwhile, when the top emission type display apparatus, that is, the left unit panel 110, and the bottom emission type display apparatus, that is, the right unit panel 120, are connected together, light emitted from the display device 112 of the top emission type display apparatus, that is, the left unit panel 110, is emitted through the substrate 111 and light emitted from the display device 122 of the bottom emission type display apparatus, that is, the right unit panel 120, is emitted through the cover 123 which includes a greater thickness than that of the substrate 111. Thus, refraction index and absorption rate of light emitted from a medium may be different according to the thickness of the medium. In exemplary embodiments, in order to balance the left and right unit panels 110 and 120, a transparent member 130 including a thickness corresponding to the thickness difference between the substrate 11 and the cover 123, may be formed on the light emitting surface of the left unit panel 110, as illustrated in FIG. 7. In exemplary embodiments, since the covers 113 and 123 are formed of a glass material, the transparent member 130 may be also formed of a same or a substantially similar glass material. Therefore, in exemplary embodiments, since light emitted from the display devices 112 and 122 passes through the left and right unit panels 110 and 120 formed of the same materials and including the same thicknesses, refraction indexes and absorption rates of the light emitted from the display devices 112 and 122 are approximately the same, and accordingly, the image is further smoothly connected.

According to the multi-display apparatus 100 including the above-described structure, image disconnection due to the connection of the display devices 112 and 122 can be reduced, and image distortion due to the perspective of the connected image can be also reduced.

Meanwhile, each of the display devices 112 and 122 may be any flat panel display device such as a liquid crystal display (“LCD”), field emission display (“FED”), plasma display panel (“PDP”), or organic light-emitting diode (“OLED”).

According to the multi-display apparatus of the present invention, image disconnection at a seam between panels can be reduced, and an image can be smoothly connected by reducing the perspective due to the step difference between the panels.

While the present invention has been particularly shown and described with reference to some exemplary embodiments thereof, it will be understood by those of ordinary skill in the art that various changes in form and details may be made therein without departing from the spirit and scope of the present invention as defined by the following claims.

What is claimed is:

1. A multi-display apparatus comprising a plurality of panels connected to each other and displaying an image,
wherein the plurality of panels comprise a top emission type display apparatus and a bottom emission type display apparatus, the top emission type display apparatus and the bottom emission type display apparatus are connected to each other such that the top emission type display apparatus and the bottom emission type display apparatus emit light in a same direction, and the top emission type display apparatus and the bottom emission type display apparatus are arranged with a step difference therebetween such that pixel boundaries of adjacent side boundary surfaces of the top emission type display apparatus and of the bottom emission type display apparatus overlap each other.

2. The multi-display apparatus of claim 1, further comprising:
a cover which surrounds each panel of the plurality of panels; and
a substrate on which each panel of the plurality of panels is attached to.

3. The multi-display apparatus of claim 2, wherein the top emission type display apparatus projects an image through the substrate, and the bottom emission type display apparatus projects an image through the cover.

4. The multi-display apparatus of claim 1, wherein the top emission type display apparatus and the bottom emission type display apparatus are connected to each other by a hinge-type connection.

5. The multi-display apparatus of claim 1, further comprising:
a transparent member formed on one of the top emission type display apparatus and the bottom emission type display apparatus, wherein the display apparatus on which the transparent member is formed includes a smaller thickness than a thickness of the other display apparatus, the thickness corresponding to a distance through which light is emitted.

6. The multi-display apparatus of claim 5, wherein the transparent member is formed such that refraction indexes and absorption rates of light emitted from the top emission type display apparatus and the bottom emission type display apparatus are substantially the same.

7. A method of manufacturing a multi-display apparatus, the method comprising:
connecting a plurality of panels to each other which displays an image,
wherein the plurality of panels comprise a top emission type display apparatus and a bottom emission type display apparatus, the top emission type display apparatus and the bottom emission type display apparatus are connected to each other such that the top emission type display apparatus and the bottom emission type display apparatus emit light in a same direction, and the top emission type display apparatus and the bottom emission type display apparatus are arranged with a step difference therebetween such that pixel boundaries of adjacent side boundary surfaces of the top emission type display apparatus and of the bottom emission type display apparatus overlap each other.

8. The method of manufacturing a multi-display apparatus of claim 7, further comprising:
surrounding each panel of the plurality of panels with a cover; and
attaching each panel of the plurality of panels to a substrate.

9. The multi-display apparatus of claim 8, wherein the top emission type display apparatus projects an image through the substrate, and the bottom emission type display apparatus projects an image through the cover.

10. The method of manufacturing a multi-display apparatus of claim 7, wherein the connecting a plurality of panels to each other includes a hinge-type connection.

11. The method of manufacturing a multi-display apparatus of claim 7, further comprising:
forming a transparent member on one of the top emission type display apparatus and the bottom emission type display apparatus, wherein the display apparatus on which the transparent member is formed includes a smaller thickness than a thickness of the other display apparatus, the thickness corresponding to a distance through which light is emitted.

12. The method of manufacturing a multi-display apparatus of claim 10, wherein the transparent member is formed such that refraction indexes and absorption rates of light emitted from the top emission type display apparatus and the bottom emission type display apparatus are substantially the same.
